(19) United States
(12) Patent Application Publication
(10) Pub. No.: US 2007/0224065 A1
(43) Pub. Date: Sep. 27, 2007

(54) Coat Pump Assembly

(75) Inventors: John S. Vondenstein, West Monroe, LA (US); William T. Thurmon, Monroe, LA (US)

Correspondence Address: BARNES & THORNBURG LLP, P.O. BOX 2786, CHICAGO, IL, 60690-2786, US

(73) Assignee: THOMAS INDUSTRIES, INC., Sheboygan, WI (US)

(21) Appl. No.: 10/599,873

(22) PCT Filed: Apr. 20, 2005
(86) PCT No.: PCT/US05/13442

§ 371 Date: Oct. 12, 2006

Related U.S. Application Data
(60) Provisional application No. 60/565,173, filed on Apr. 23, 2004.

(51) Int. Cl. F04C 18/08; B05D 5/12; B05D 7/22

(52) U.S. Cl. 418/9; 427/130; 427/181

(57) ABSTRACT

A roots blower pump (10) has its internal gaps between relatively moving parts reduced by adding a liquid coating to the intake of the pump while operating the pump. The liquid coating cures to a solid surface on the moving parts, presenting opposing relatively moving surfaces that mate with one another to reduce leakage losses.

### CROSS-REFERENCE TO RELATED APPLICATION

This application claims benefit to U.S. Provisional Patent Application No. 60/565,173 filed on Apr. 23, 2004.

### STATEMENT CONCERNING FEDERALLY SPONSORED RESEARCH OR DEVELOPMENT

Not applicable.

### FIELD OF THE INVENTION

This invention relates to fluid pumping, and in particular to reducing leakage losses in fluid pumping apparatus that has close running fits.

### BACKGROUND OF THE INVENTION

Fluid power apparatus oftentimes rely upon close running fits to keep leakage losses to a minimum and thereby to be as efficient as possible. For example, a small Roots blower consists of two or more lobes rotating opposite each other in a pump chamber to move air. The internal parts of the small Roots blower never come in contact with each other, thereby producing no friction and requiring no lubrication. The result is a cool running, highly efficient pump if the clearances are kept to a minimum. The tighter the clearances, the higher level of efficiency the pump can achieve, particularly when pumping gases, which have a very low viscosity and therefore a low resistance to leakage.

The challenge in manufacturing a small Roots blower is precisely machining the parts so as to produce the maximum amount of air flow, and thereby achieve the maximum, or at least a reasonable, efficiency. Since there are no contacting surfaces in the pump, air has the opportunity to leak through the spaces between the parts, which in operation are moving relative to one another. The gaps in between the two rotating lobes and between the pump walls and the lobes must be kept to a minimum or else the air or other gas being pumped will simply leak by them. The precision levels required of the parts make them impractical to machine at a reasonable cost, particularly if the parts are small, since the volume of gas pumped is correspondingly small which makes critical the reduction of leakage losses.

A typical process for manufacturing a small Roots blower requires parts to be made in matched sets, i.e., the parts for the pump are made specifically to be assembled with each other for that one unit. With this manufacturing technique, it is difficult to produce parts at mass production levels, and there is a very high cost associated with the process.

### SUMMARY OF THE INVENTION

The invention provides a method, and a fluid power device made according to the method, in which after the fluid power device is assembled the device is driven so as to move its element relative to its chamber, and while the device is being so driven a coating material is introduced into the chamber to coat surfaces of the element and the chamber. The coating material is cured at least partially while the device is being so driven so as to adhere the coating to surfaces of the element and the chamber and reduce clearances between the element and the chamber. This avoids the high costs of precision made parts and a matched set assembly method, and reduces the leak paths to a minimum.

In a preferred form, the coating material is a material that cures to a solid lubricious surface, for example a material that includes a lubricant in a liquid binder that cures solid. Preferably, the device is operated at a relatively slower speed when the coating material is added to the chamber, and thereafter is operated at a relatively faster speed after the material has cured sufficiently so as to curtail flow.

In the preferred embodiment, the fluid power device is a Roots blower, the element is a lobe, the device has a second lobe that mates with the element, and surfaces of both lobes and the chamber are coated with the coating material. Such a device is particularly suited to the invention since there is little or no sliding in the device, but it relies on close running fits, i.e., with a small gap so that there is no sliding contact, for operation of the device.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a perspective view of a Roots blower pump incorporating the invention;

FIG. 2 is an exploded perspective view of the pump of FIG. 1; and

FIG. 3 is a fragmentary magnified and exaggerated cross-sectional view illustrating the coating layers on a lobe and the compression chamber of the pump of FIGS. 1 and 2.

### DETAILED DESCRIPTION OF THE PREFERRED EMBODIMENT

In the preferred embodiment, the invention applies a coating to an assembled Roots blower by introducing an amount of the coating into the intake port of the Roots blower while operating the Roots blower. The coating fills the gaps and at least partially cures while the Roots blower is running, and any excess coating is expelled, leaving the parts of the Roots blower with very close running fits so as to improve the efficiency of the Roots blower.

It is believed that any of many different coatings could be applied according to the invention. Any coating that will stick to the parts and is compatible with the material of them, that will maintain a surface resistant to the fluid being pumped and that will not expand or contract excessively with temperature or pressure changes may be used. In the preferred embodiment, a lubricant suspended in a liquid binder that cures solid has been found acceptable. Such a material is Slip Plate No. 1, which is commercially available from Acrotech Industries d.b.a. Superior Graphite Co. (www.slipplate.com), Lake of the Hills, Ill. This material is 74% graphite, bonds to metal and most plastic surfaces and cures to a solid lubricious surface. For larger gaps to be filled in, a thicker consistency is preferred so that the gaps can be filled with as few applications of coating as possible, preferably with only one coat. However, more than one application can be made, with the coating layers cured or partially cured prior to the next application, if the coating consistency is thinner, or if the gaps to be filled are larger. The tack free drying time of Slip Plate No. 1 is rated at 60 to 90 minutes, but it has been found this time is greatly reduced when applied to the Roots blower pump while running. With the pump running, air is being forced through the chamber over the liquid lubricant, which accelerates the drying time. The result is a small Roots blower with coated parts that reduce the gaps between parts within 15 minutes of cure time (single application of coating). Other liquid coating materials may also be used.

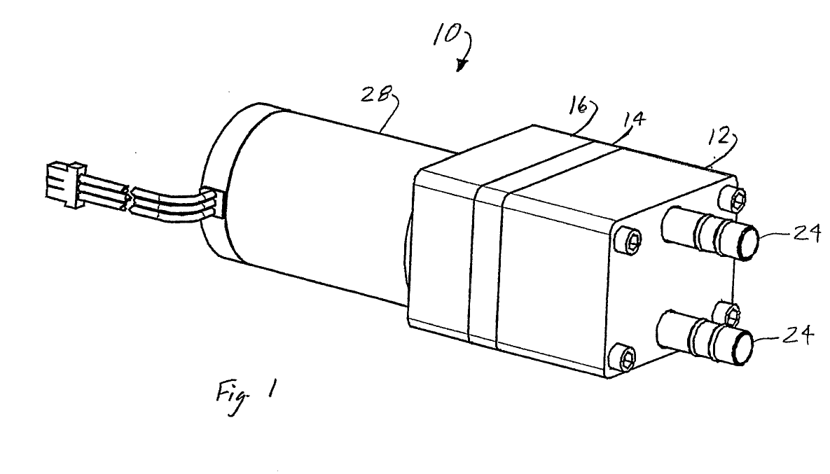

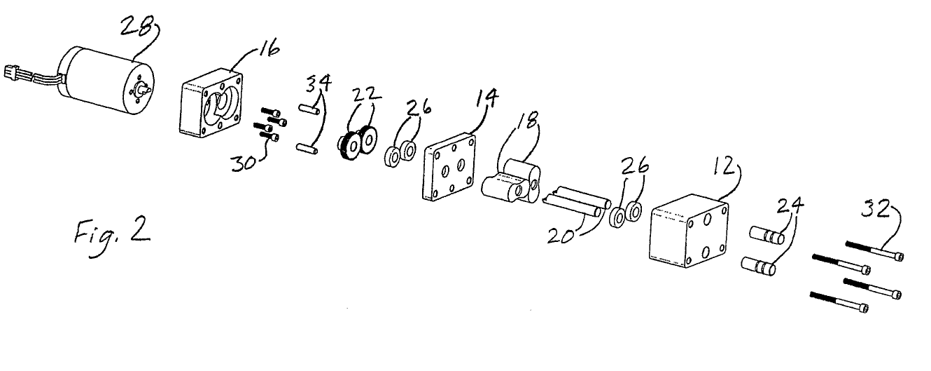

Referring to FIGS. 1 and 2, a small Roots blower 10 is made up of several components. They are the pump housing 12, interface plate 14, gear housing 16, two rotating lobes 18, two shafts 20, two gears 22, two hose barbs 24, four bearings 26, a motor 28, screws 30 and 32 for fasteners, and dowel pins 34. The pump housing 12, interface plate 14, gear housing 16, and hose barbs 24 are all anodized aluminum. The two rotating lobes 18 are aluminum as well, but are sand blasted lightly to achieve a rough surface for the coating to adhere to. The two gears and shafts are made of stainless steel and the bearings are chrome plated, as these parts are not coated with the coating. The motor used is a brushless DC motor.

The small Roots blower 10 is first assembled prior to coating. The parts should be clean and free of any oil or foreign debris that may affect the ability of the coating to adhere to the lobes and compression chamber surfaces. Two of the bearings 26 are received in recesses (not shown) of the interface plate 14 and attached therein with retaining compound (e.g., Loctite™ adhesive), and the dowel pins 34 are pressed into the gear housing 16 or the interface plate 14. The two gears 22 are pressed onto the D-shaped ends of the shafts 20. Both shafts 20 are pressed into the inner bore of the bearings 26 in the interface plate 14 with the gears 22 meshing. The two lobes 18 are placed in a fixture orienting them 90 degrees to each other and they are pressed simultaneously onto the shafts 20 that extend from the plate 14. The two bearings 26 are then pressed onto the ends of the shafts 20 on the lobe side (right side in FIG. 2). The hose barbs 24 are attached to the inlet and outlet ports in the pump housing 12 with retaining compound (e.g., Loctite™ adhesive) and the pump housing is placed onto the interface plate 14 and lobe 18 assembly to make the pump assembly. The gear housing 16 is attached to the motor 28 with screws 30, the gears are lubricated and the pump assembly is fastened to the motor 28 and gear housing 16 assembly with the screws 32.

After the pump is assembled, the coating is applied. The unit should be running with a lobe rotation speed between 1500 and 2000 rpm. Greater or lesser speeds may be used. The objective is to create a coating of all of the surfaces of the lobes and pump cavity while not flinging the coating off excessively due to centrifugal force or due to too high of a flow rate through the pump. A predetermined amount of the coating is placed into the pump through the intake port. This may be done by injection with a syringe, eye dropper, metering pump, or similar implement, or by pouring it in, with the pump oriented so that the intake port (the intake one of the hose barbs 24) is pointed upwardly, to keep the coating from running out of the pump). If the outlet port is not also pointed up, it may need to be oriented to prevent the coating from flowing out of the compression chamber. It may also be advantageous in some applications to vary the orientation of the pump after the coating is added to it and it is running, so as to use gravity to more evenly coat the surfaces of the compression chamber and lobes, although this has not been found necessary in the preferred embodiment. The amount of coating to be used should be only the amount sufficient to coat the surfaces and fill the gaps, as any excess results in waste. For a small Roots blower (compression chamber external dimensions of approximately 2″×2″×6″; flow rate of 1.7 cfm at open flow at 3250 rpm; 1.0 cfm at 1.5″ Hg at 3250 rpm), the amount of coating needed is approximately 3 ml., but for any particular pump the amount to use can easily be determined by trial and error. If too little coating is used, there will not be enough coating to fill all the gaps, which may require a second coat. If too much coating is used, the excess will be blown out when the pump is speeded up (see below) to remove the excess, and the excess will be wasted.

After the coating is added, the unit is run for approximately for five minutes at this speed with the coating to disperse as evenly as possible throughout the pump chamber and onto the lobes. The unit is then sped up to 3000 rpm and run for an additional 5 to 10 minutes to blow out excess coating and assist in curing the coating.

When the coating is cured or at least partially cured to the extent that it is no longer flowing inside the pump, the unit is checked to verify that it meets the required flow at load. If the unit does not meet the required flow point, another application of the coating is made as described above to fill in the remaining air voids and the unit is rechecked for flow.

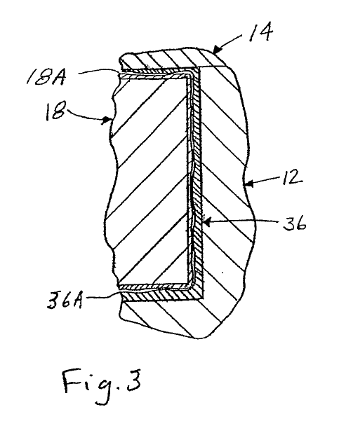

All external surfaces of the lobes 18 and all internal surfaces of the compression chamber defined by the pump housing 12 and interface plate 14 are typically coated, and the coating thickness may not be perfectly even. For example, if the lobe coating at a particular point has a relatively greater thickness, the portion of the coating on the other lobe or on the chamber that interfaces with that particular point may be of a reduced thickness. In any event, the gap is filled in by the coatings on the two mating parts such that the surface of the coating on one part should generally conform to and mate with the surface of the coating on the other part. This is illustrated in FIG. 3, showing a portion of the interface between lobe coating 18A and the coating 36A of the chamber 36, which is defined by housing 12 and interface plate 14. The coating typically cannot make it into the shaft holes in the interface plate 14 or into the bearings 26, which are preferably sealed bearings. Any coating on the hose barbs 24 can be removed prior to curing to improve the aesthetic appearance of the pump.

The result from this assembly process is a much more efficient small Roots blower due to the tighter running clearances inside the pump chamber. This process removes much of the cost endured when the parts have to be machined to near impossible machining tolerances and it obviates parts matching and custom assembly.

A process of the invention can be applied to any type of pump or fluid power device that relies on close running fits, like Roots blowers do as in the preferred embodiment. A process of the invention may also be applied to refurbish or recondition used fluid power devices.

A preferred embodiment of the invention has been described in considerable detail. Many modifications and variations to the preferred embodiment described will be apparent to a person of ordinary skill in the art. Therefore, the invention should not be limited to the embodiment described.

We claim:

1. In a method of making a gaseous fluid power device having a housing that defines a chamber and contains at least one moving element that moves relative to the chamber and thereby changes the density of the gas in the chamber, the moving element having a close running fit with the chamber, the improvement wherein after the fluid power device is assembled the device is driven so as to move the element relative to the chamber and while the device is being so driven a coating material is introduced into the chamber to coat surfaces of the element and the chamber, and the coating material is cured at least partially while the device is being so driven so as to adhere the coating to surfaces of the element and the chamber and reduce clearances between the element and the chamber.

2. The improvement of claim 1, wherein the coating material is a material that cures to a solid lubricious surface.

3. The improvement of claim 1, wherein the coating includes a lubricant in a liquid binder that cures solid.

4. The improvement of claim 1, wherein the coating material is added to the chamber through an intake port of the chamber.

5. The improvement of claim 1, wherein the device is operated at a relatively slower speed when the coating material is added to the chamber, and thereafter is operated at a relatively faster speed.

6. The improvement of claim 5, wherein the device is operated at the relatively slower speed for a period after the coating material is added to the chamber and after the period the device is operated at the relatively faster speed.

7. The improvement of claim 1, wherein the device is a pump, the element is a pumping element and the chamber is a pump chamber.

8. The improvement of claim 1, wherein the fluid power device is a Roots blower, the element is a lobe, the device has a second lobe that mates with the element, and surfaces of both lobes and the chamber are coated with the coating material.

9. A gaseous fluid power device having a housing that defines a chamber and contains at least one moving element that moves relative to the chamber and thereby changes the density of the gas in the chamber, the moving element having a close running fit with the chamber, the improvement wherein the element and the chamber each have solid coatings on at least portions of their surfaces, said solid coatings having been deposited in liquid form on the surfaces of the element and chamber by flowing the coating into the chamber and onto the element while operating the device and at least partially curing the coating deposited on the element and the chamber while operating the device, the coating defining respective solid surfaces when cured, and at least a portion of the surface of a solid coating on the chamber mates in a close running fit with a portion of the surface of a solid coating on the element.

10. The device as claimed in claim 9, wherein the device is a pump.

11. The device as claimed in claim 9, wherein the device is a Roots blower.

12. The device as claimed in claim 9, wherein the solid surface of the coating is lubricious.

13. The device as claimed in claim 8, wherein the device is a Roots blower having two lobes, each lobe being coated with the coating and mating with the other lobe and with the chamber.
